(19) United States
(12) Patent Application Publication
(10) Pub. No.: US 2005/0251455 A1
(43) Pub. Date: Nov. 10, 2005

(54) Method and system for purchasing access to a recording

(76) Inventor: Peter V. Boesen, Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/842,207

(22) Filed: May 10, 2004

(51) Int. Cl. G06F 17/60

(52) U.S. Cl. 705/26

(57) ABSTRACT

A method, apparatus and system for purchasing audio or video events is disclosed. A user who is listening to an audio or video source initiates a purchase in a convenient manner. According to one method a determination is made as to the source of audio or video proximate a user. Next there is an automatic receiving of identifying information associated with the source of audio or video. Finally, a request is received from the user for purchase of the recording. The apparatus can include a phone or other device that includes a buy button. The user can also select or preset delivery options so that a recording is conveniently delivered to the user.

### BACKGROUND OF THE INVENTION

The present invention relates to a method and system for purchasing during or after exposure to a recording. More specifically, but without limitation, the present invention relates to providing immediate and convenient access to audio recordings at the time of audio exposure.

Problems in the Art

The present invention addresses a number of distinct and currently distinctly prominent problems in the art. The present invention should not be limited to the scope of the problems described herein.

This patent offers a novel and immediate solution to the major problem relating to unauthorized use of copyrighted works, including unauthorized use of audio recordings. The invention recognizes that one of the major contributing factors to piracy of copyrighted works is that legitimate copies of such copyrighted works, or authorized access to the copyrighted works, cannot be provided in a manner that is convenient to the listener. The present inventor has further recognized that the inconvenience in obtaining a legitimate copy of a copyrighted work can also serve to reduce the sales of the copyrighted work.

The inconvenience of obtaining a legitimate copy of a copyrighted work is present in a number of situations. Consider the use of radios in cars. Radios are typically utilized while driving the vehicle. One of the problems most often encountered is that a listener will hear music, or other audio events that they particularly enjoy, but is unaware of the creator. The listener may desire to obtain a copy of the music or audio event for their own personal listening pleasure, yet there are significant and important obstacles to doing so.

One difficulty is in identifying the very music being played by artist, and the title of such work. Sometimes this information is presented by an announcer prior to the music being played, but oftentimes not. After listening to the music, one becomes interested in purchasing the selection but usually cannot remember the artist, or title of the song because there was simply no way to easily recall this information while operating the vehicle and listening to the selection.

Even if one hears the artist and title of the song after the music has completed, one would preferably want to write this information down instead of relying upon memory, which is typically fleeting. This is problematic when driving, as it would remove the driver's concentration from the road.

A further problem is that even if one has properly noted the artist and song, there may be great difficulties in obtaining a recording of the music. Although not a major problem with popular music, there can be significant problems when the music is a lesser known jazz or classical selection that is played infrequently and not widely available at music stores, which themselves are under significant pressure and becoming harder to find.

The problems of obtaining identifying information about an audio event and purchasing a recording of the event is not confined to the use of car radios. This problem applies to any number of situations where audio is being played, including when the audio is live, and a listener desires to purchase a recording of the audio or video event. What is needed is a method, apparatus, and system for purchasing an audio or video recording that is convenient to the listener.

Therefore, it is a primary object, feature, or advantage of the present invention to improve upon the state of the art.

It is a further object, feature, or advantage of the present invention to provide a method, apparatus, and system for purchasing an audio recording of an audio event that is convenient to listener.

A still further object, feature, or advantage of the present invention is to provide a method, apparatus, and system for purchasing an audio or video recording of an audio or video event that encourages sales of the recording, and therefore discourages unauthorized copying.

Another object, feature, or advantage of the present invention is to provide a method, apparatus, and system for purchasing an audio or video recording of an event that allows a listener to purchase the recording of the event during, or shortly after the audio event.

Yet another object, feature, or advantage of the present invention to provide a method, apparatus, and system for purchasing an audio recording of an audio event that does not significantly distract the driver of a motor vehicle.

It is a further object, feature, or advantage of the present invention to provide a method, apparatus, and system for purchasing an audio or video recording of an event that provides for delivery of the recording to the user.

A still further object, feature, or advantage of the present invention to provide a method, apparatus, and system for purchasing an audio or video recording that does not require the listener to take notice of the name of the artist or name of the song.

Another object, feature, or advantage of the present invention to provide a method, apparatus, and system for purchasing an audio recording that quantifies the relationship between an audio event and sales of audio recordings of the audio event.

These and/or other objects, features or advantages of the present invention will become apparent from the specification and claims that follow. These objects, features, or advantages of the present invention do not limit the invention as the present invention can provide other features and advantages in different embodiments and different contexts.

### SUMMARY OF THE INVENTION

The present invention is a method, apparatus, and system for purchasing audio events. A user who is listening to an audio event, in person, on the radio, or otherwise can select audio events to be purchased and delivered. Preferably, the purchase is initiated through pressing a buy button. The purchase transaction can occur over a two-way communication system, such as, but not limited to, a cellular telephone. The cellular telephone receives identifying information for the audio event directly, through a short range communication link, or otherwise.

According to one aspect of the invention, the audio events of interest to a user are associated with a radio. For example, the present invention provides a method that includes listening to an audio event transmitted to a radio and then pressing a button to initiate purchase of a recording of the audio event. According to another aspect of the present invention, a system for providing radio audio and for purchasing of audio recordings is disclosed. The system includes a radio receiver for playing audio, an intelligent control electrically connected to the radio receiver, a transceiver operatively connected to the intelligent control for transmitting and receiving purchase information, and a user interface operatively connected to the intelligent control adapted for receiving a buy command from a user.

According to another aspect of the invention, a method of purchasing an audio recording is disclosed. The method includes playing an audio event transmitted to a radio, receiving a purchase request from a user listening to the radio, transmitting the purchase request over a network with audio or video event identifying information, and receiving verification of the purchase over the network.

According to another aspect of the present invention, a method of selling audio or video recordings is disclosed. The method includes receiving a purchase request from a radio or digital video interface device that a user is listening to, identifying a recording to sell based on the purchase request, and completing a financial transaction with the user for the audio recording.

The present invention also provides for methods, apparatus, and system related to use of a phone in the purchase of audio recordings. In one embodiment of the present invention, a phone is adapted for purchasing access to an audio recording of audio associated with a source of audio. The phone includes a phone housing, a user interface for selecting the source of audio and initiating a purchase of the audio recording of audio associated with the source of audio, and a communications link to an ordering system for ordering access to the audio recording. Preferably the phone includes a “buy” button which can be a joystick-type button. This easily allows for tracking of the user for buying purposes.

According to another aspect of the present invention, a system for providing convenient purchase of access to a recording of audio is disclosed. The system provides for a device for producing audio to have an associated short range transceiver such as a BLUETOOTH or UWB transceiver. The short range transceiver is adapted to transmit information describing the audio for use in purchasing access to the audio without transmitting the audio itself. A phone having a second short range transceiver is in operative communication with short range transceiver of the device that produces audio. Thus, the phone can receive identifying information associated with the audio and can initiate the purchase of an audio recording.

According to another method of the present invention, the present invention provides for convenient purchase of a recording through determining at least one source of audio proximate a user, automatically receiving identifying information for the at least one source of audio or video input, and receiving a request from the user for purchase of a recording of the audio. The steps of determining and receiving may be performed by a phone.

### BRIEF DESCRIPTION OF THE DRAWINGS

FIGS. 1-2 provide a pictorial representation of one embodiment of a phone according to the present invention.

FIG. 3 provides a pictorial representation of the phone of FIGS. 1-2 with a user interface that allows the source of audio and delivery preferences to be selected.

FIG. 4 is a block diagram of one embodiment of the present invention.

FIG. 5 is a pictorial representation of another embodiment of the present invention.

FIG. 6 is a pictorial representation of another embodiment of the present invention.

FIG. 7 is a block diagram of another embodiment of the present invention.

FIG. 8 is a pictorial representation of yet another embodiment of the present invention.

FIG. 9 is a block diagram of another embodiment of the present invention.

FIG. 10 is an overview of a system of one embodiment of the present invention.

FIG. 11 is graphical representation of one embodiment of selection options according to one embodiment of the present invention.

FIG. 12 is an overview of a system of another embodiment of the present invention.

### DETAILED DESCRIPTION OF THE PREFERRED EMBODIMENT

The present invention includes a method and system for purchasing recordings of audio or video events. The present invention is described in terms of the preferred embodiments that follow. The present invention is not limited to these preferred embodiments and the claims of the patent should not be construed to be so limiting.

The present invention provides for a phone being used to collect identifying information about an audio event and to initiate a purchase of an audio recording of the audio event. The present invention contemplates that the collection of information and initiation of a purchase can be performed in any number of ways.

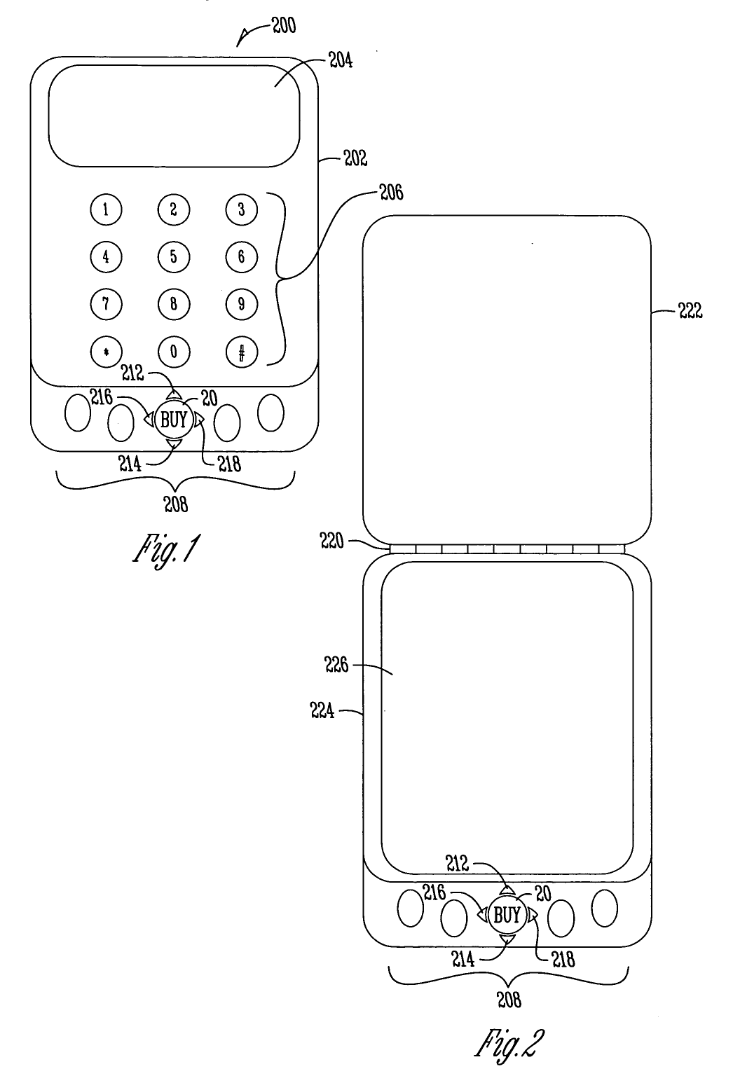

In FIG. 1, a phone 200 is shown. The phone includes a phone housing 202. The phone also includes a first display area 204. There are a plurality of buttons 206 shown, preferably configured as a dial pad. There is a second plurality of buttons 208 also shown to provide for additional functionality. This second plurality of buttons 208 preferably includes a “buy” button 20. The purpose of the buy button 20 is to initiate the purchase of an audio recording. The buy button 20 is preferably a joystick type button that allows the button 20 to be pressed upward towards top member 212, downward to bottom member 214, leftwardly to left member 216, and rightwardly to right member 218.

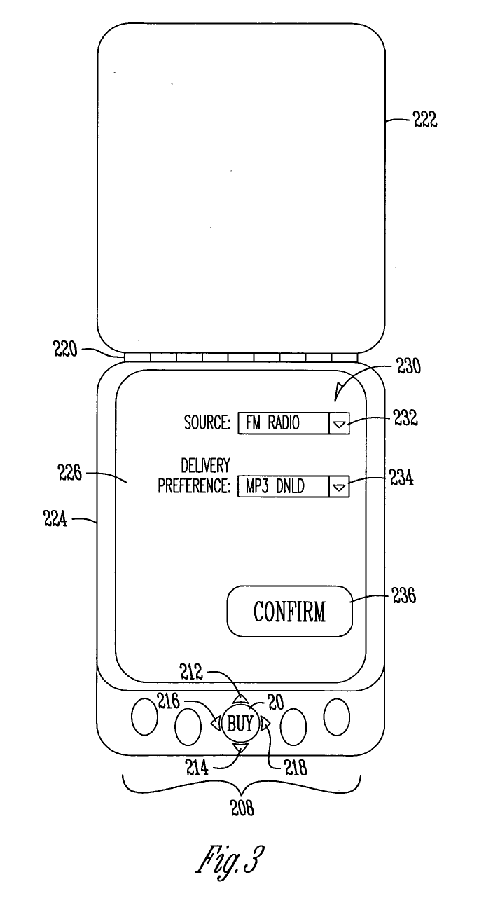

FIG. 2 illustrates another type of phone, similar to the phone of FIG. 1, but with an open, as opposed to closed, positioning capability. The first body 222 is hinged to the second body 224 through a hinge 220. As shown in FIG. 2, the phone includes a first body 222 and a second body 224. There is also a second display 226 shown. The present invention is not limited to the particular configuration of phone shown. The present invention contemplates numerous variations in the type of phone, including its physical configuration.

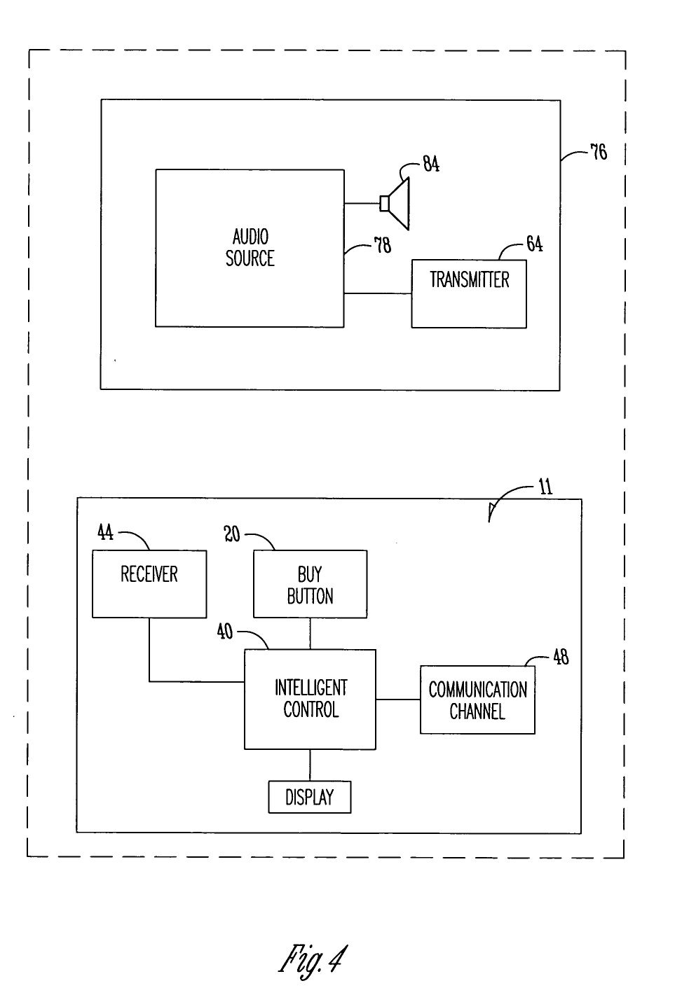

FIG. 3 illustrates the phone of FIGS. 1-2 with a screen 230 on the display that allows the user to select the source of audio that the user wishes to purchase an audio recording of and the user's delivery preference. The combination of the buttons and the screen form one embodiment of a user interface. The user can select the source of audio or video encountered from the drop-down list box 232 and a delivery preference from the drop-down list box 234. The present invention contemplates any number of sources of audio can be used. These include sources of audio directly associated with the phone, such as an FM radio built-into the phone. The sources of audio that can be used also include sources of audio for which the phone receives identifying information. For example, as will later be discussed, the phone can receive identifying information for audio associated with public performances, local broadcasts, satellite broadcasts, other types of audio, or digital video. The identifying information can be communicated to the phone through short range transmission, such as through Wi-Fi, BLUETOOTH or UWB.

In addition to specifying the particular source for the recording that the user wishes to purchase, the user can also select one of a number of delivery preferences. The delivery preferences are discussed herein in more detail, but can include download to a hard drive MP3 downloads, digital media such as CDs, DVDs, or audio cassettes, or other types of analog media. The present invention is not limited to a particular manner of delivery.

FIG. 3 also illustrates a “Confirm” button 236 which can be used to confirm a purchase. The present invention contemplates that pressing the buy button 20 once again can have the same effect as selecting “confirm.”

FIG. 4 illustrates a block diagram according to one embodiment of the present invention. In FIG. 4, a device 76 for producing audio or video is disclosed. The device 76 includes an audio source 78, a speaker 84, and a transmitter 64. The transmitter 64 transmits identifying information for the audio source 78 or identifying information for the audio being played by the audio source 78. Such a device can be used in any number of environments. For example, such a device can be present at amusement parks, or historical areas, or other places of interest. In such a use, the audio source can play an appropriate recording that may be of interest to a user. The transmission of identifying information allows a user to receive that information and then purchase a recording of the audio being played. Thus, it should be clear that the present invention contemplates use with any number of types of audio source.

In FIG. 4, a purchasing device 11 is also shown. The purchasing device 11 can be a phone. The purchasing device 11 includes an intelligent control 40. The intelligent control 40 is operatively connected to a buy button 20, a receiver 44, a display, and a communication channel 48. The receiver 44 receives identifying information from the transmitter 64 about an audio event. If a user desires to buy a recording of the audio event, the user can initiate a transaction with the buy button 20 to purchase an audio recording. The purchase can be transacted by sending appropriate information over the communication channel 48.

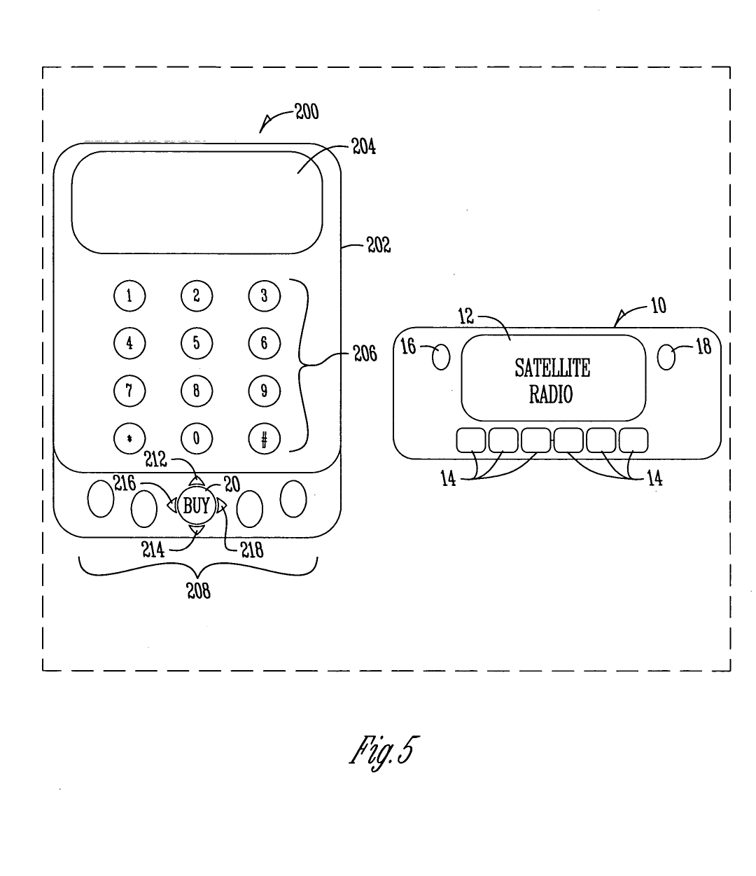

In FIG. 5, a satellite radio interface 10 is shown. The satellite radio 10 is preferably capable of receiving XM or SIRIUS transmissions. The satellite radio 10 includes a display 12, a plurality of radio controls such as radio control buttons 14 which can define preset channels and radio controls 16 and 18 which control channel and volume, respectively. The present invention contemplates that numerous other types or variations of radio controls can be used. The present invention provides for communication between the satellite radio 10 with the phone 200. Thus, a user can select the satellite radio as an audio source and thereby purchase audio events being played by the satellite radio. In such an embodiment, the satellite radio 10 communicates identifying information for the radio event to the phone 200. In this embodiment of FIG. 5, communication between the phone 200 and the satellite radio 10 is wireless and preferably through a short range transmission such as through BLUETOOTH or UWB.

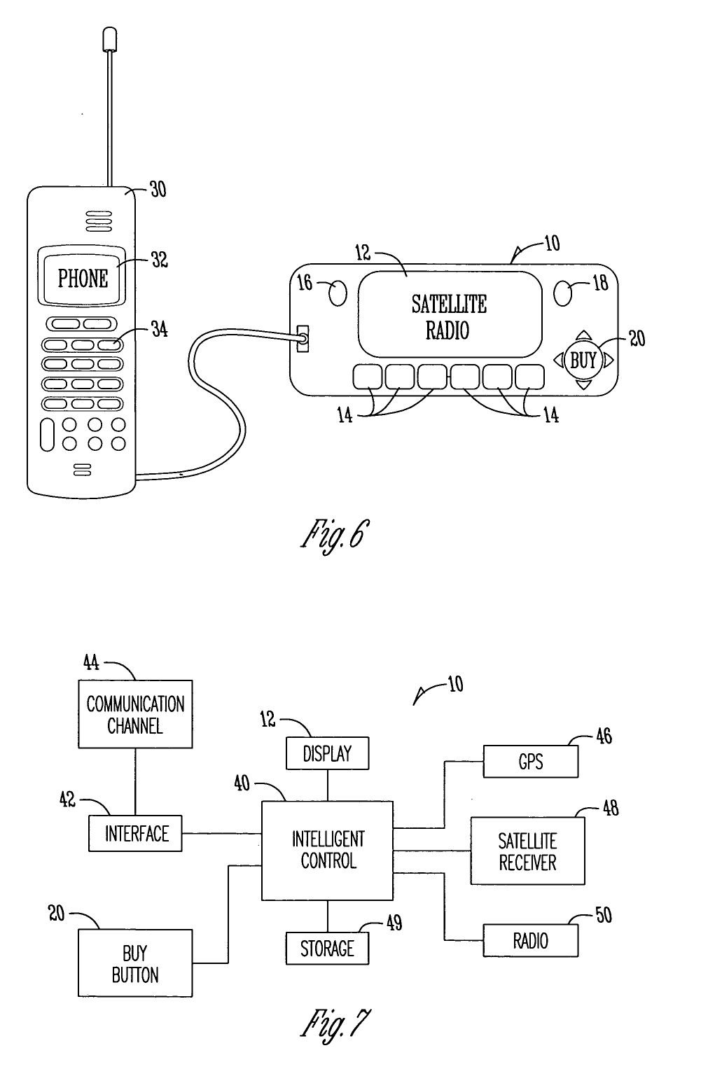

FIG. 6 illustrates an embodiment of the invention similar to that shown in FIG. 5. In FIG. 6, however, the satellite radio 10 includes a buy button 20, but does not include its own two-way communication channel. In such an embodiment, the satellite radio 10 can be operatively connected to a phone 30 having a display 32 and a keypad 34 via a wired connection. In such an embodiment, the present invention provides for proper interaction between the satellite radio and the phone for communicating purchase information from the satellite radio 10, using the phone 30.

In FIG. 6, there is a buy button 20. The buy button 20 is conveniently placed as a part of the satellite radio 10. Thus, a listener of the radio can simply press the BUY button 20 to purchase a recording of a currently playing audio event. A telephone 30 with display 32 and keypad 34 is shown operatively connected to the satellite radio 10. The present invention contemplates that the purchase request can be transmitted over cellular or satellite network. When a request is made, audio event identifying information such as channel or station as well as buyer identifying information is transmitted over the network so that the purchase can be made. The present invention also contemplates that the purchaser may also need to verify the purchase through entering a code on the satellite radio or the phone 30 at the time of the purchase or may otherwise need to verify the purchase prior to purchase and delivery. Although a satellite radio and cellular telephone are shown, the present invention contemplates that other types of radios and other types of communications channels can be used. A satellite radio is preferred for a number of reasons. First, a satellite radio is a part of a large a network as opposed to independent ratio stations. This simplifies the process of resolving purchase requests. For example, only a time (in some instances a time and location) and channel information is needed in order to determine the audio event associated with that particular time. Although the present invention contemplates other types of transmissions, such as FM radio transmissions, satellite radio presently provides an ideal platform for the present invention.

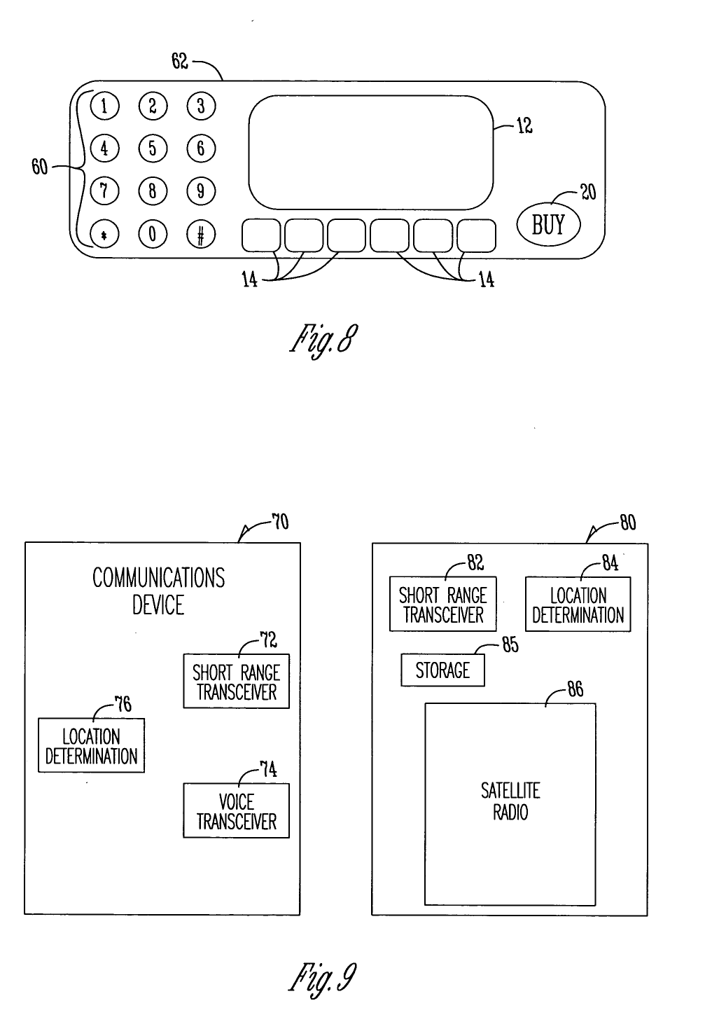

FIG. 7 provides a block diagram of one embodiment of the present invention. In FIG. 7, a satellite radio 10 is shown. The satellite radio 10 includes an intelligent control 40. The intelligent control 40 can include a processor, microcontroller, microprocessor, integrated circuit, or other type of intelligent control. Operatively connected to the intelligent control 40 is a display 12 and a satellite receiver 48 for receiving satellite radio signals. The satellite radio includes radio controls 50 which can be used for defining channel presets, changing volume, changing channels, and otherwise controlling radio functions. The buy button 20 is also operatively connected to the intelligent control 40. The buy button 20 is considered to be a part of a user interface for purchasing a recording of an audio event. The present invention contemplates that instead of using buy button 20, the user interface can provide for receipt of voice commands to purchase a recording of an audio event or other types of user interface can be used.

A communications interface 42 is also electrically connected to the intelligent control 40. The communication interface 42 allows a communications channel 44 to be established. The communications interface 42 allows the intelligent control 40 to communicate over a communications channel 44 with a service that provides administration for purchase requests. The communications channel 44 can be a satellite link or a cellular communications channel or can be another type of communications channel, such as a SMS protocol channel that allows for the sending and receiving of short text messages. The communications channel may also be a communications channel that is associated with a motor vehicle, such as ONSTAR. It is preferred that the communications channel be bidirectional so that verification of receipt of purchase requests can be given or optionally, addition information can be requested. The type of communications channel used is in no way limited to the specific types of communication channels described herein as one skilled in the art will appreciate that a number of different types of communications channels can be used and the decision of which type of communication channels to use may be made based on a particular implementation of the present invention in a particular environment. Preset information regarding financial information of the purchaser may be stored and verified through confirmation pass codes stored with the satellite or cellular user contract.

An optional GPS receiver 46 is also operatively connected to the intelligent control 40. When present, the GPS receiver 46 provides accurate time and location information. Time and or location information from the GPS receiver can accompany a purchase request to help identify a requested audio event along with channel identifying information. The present invention also contemplates that where satellite radio is used, the satellite radio transmissions includes identifying information for the audio event and that this identifying information can accompany a purchase request.

A storage device 49 is also operatively connected to the intelligent control 40. The storage device 49 is preferably a magnetic or solid state memory, such as a hard drive or a FLASH drive. The present invention, however, is not limited to the particular type of memory or storage device used. One of the advantages of having a storage device 49 is that music can be downloaded directly to the storage device 49 for future enjoyment. When music is ordered, a preference can be set to directly download the music to a storage device 49 associated within the vehicle so that the music will always be available to the driver of the vehicle.

FIG. 8 illustrates another embodiment of the present invention. In FIG. 4, a device 62 has a housing 62 that hoses both a satellite radio and a voice communications transceiver. In FIG. 8, the device includes a display 12 with radio controls 14 and a buy button 20. A telephone keypad 60 is also shown. Alternatively, the voice communications transceiver, instead of being integrated with the satellite radio, can be interfaced to the satellite radio through a cable or operatively connected through BLUETOOTH, UWB, infrared, or other types of short range wireless transceivers.

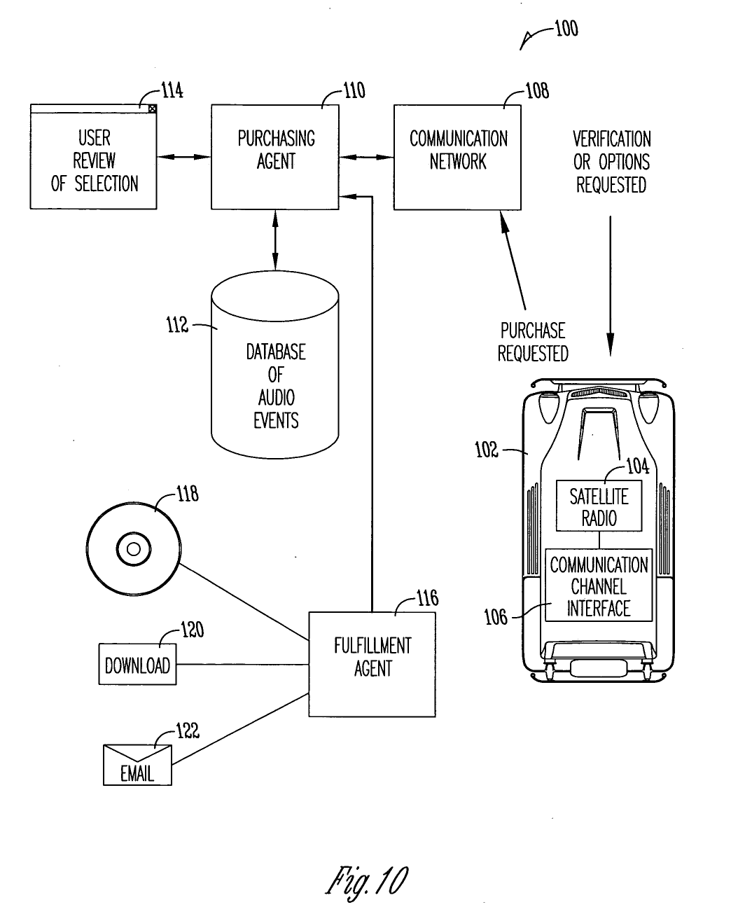

FIG. 9 illustrates another embodiment of the present invention. In FIG. 9, a device 80 includes a satellite radio 86, a short range transceiver 82, and an optional local determination unit 84. The short range transceiver can be a BLUETOOTH transceiver, a UWB transceiver, or other type of short range transceiver. The optional location determination unit 84 can be a GPS unit or other type of location device. The short range transceiver 82 is in operative communication with a short range transceiver 72 associated with a communications device 70. The communications device 70 also includes a voice transceiver 74. Preferably the communications device 70 is a phone or smart phone, but the present invention contemplates that other types of communications devices can be used. The link between the short range transceiver 72 of the communication device 70 and the short range transceiver 82 of the device 70 allows purchasing requests and purchase verification information concerning audio events played by the satellite radio 86 to be communicated over a communications channels such as that provided by voice transceiver 74.

The present invention contemplates that the devices 80 can be housed within a vehicle, including being housed within a dashboard of a car. The device 80 can also include a storage device 85. The storage device 85 is a memory such as a magnetic memory, a hard drive, a flash drive, or an optical drive. The present invention contemplates that works such as songs can be stored directly on the storage device 85 so that a listener can order a selection being played on their satellite radio 86 and have the selection delivered to the storage device 85.

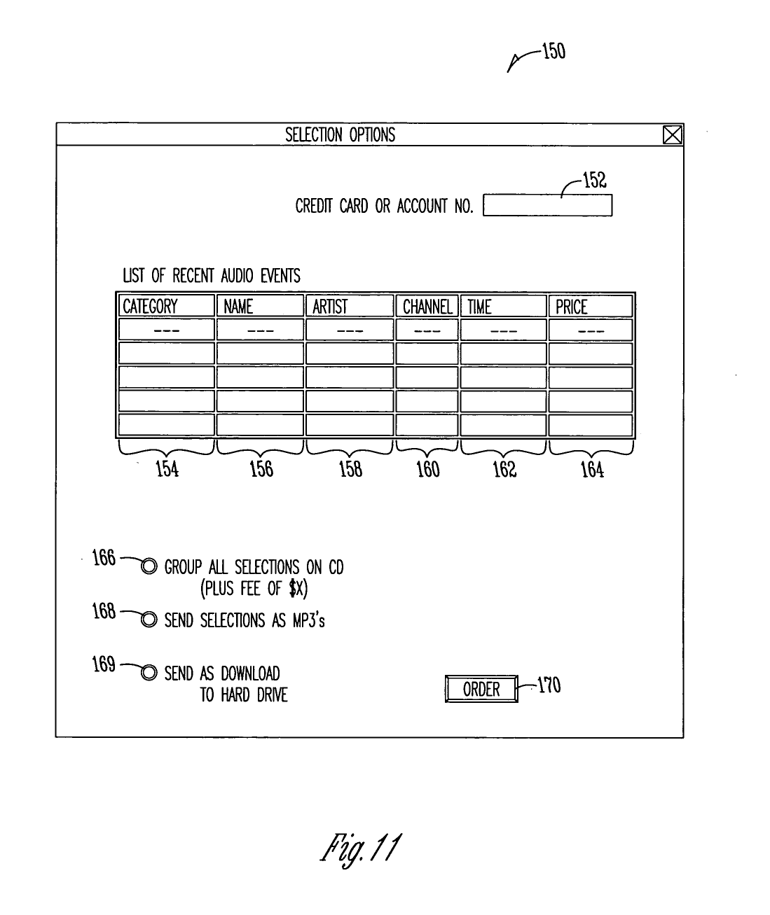

FIG. 10 provides an overview of one embodiment of the system of the present invention. In FIG. 10 a system 100 is shown. A motor vehicle 102 includes a satellite radio 104. A communications channel interface 106 is operatively connected to the satellite radio 104. A purchase request is made over the communications channel to a communications network 108. Optionally the communications network can send verification requests or options requests to the communication channel interface 106. The communications network 108 is also operatively connected with a purchasing agent 110 which can include computers, software, and combinations of computers and software. The purchasing agent 110 can access a database of audio events 112. Thus, when given proper identifying information about an audio event-such as the identifying information included in a purchase request, the purchasing agent can determine additional information about the audio event.

A user interface for review of selections 114 is optionally provided. The present invention contemplates that instead of buying a selection immediately, the user can instead place the information concerning a particular audio event into a shopping cart or otherwise flag the audio event for potential purchase. The user can then later review these selections to determine if the user wishes to purchase the particular selections. Once a user selects the audio events to purchases, a fulfillment agent 116 which may be automated in whole or in part provides for fulfillment of the purchases. The present invention contemplates that the audio events can be recorded onto digital media such as a CD 118 (or other digital media). Alternatively, the audio events can be made available to a user as downloads 120 or can be sent as attachments to an email 122 that is sent to the user or other recipient.

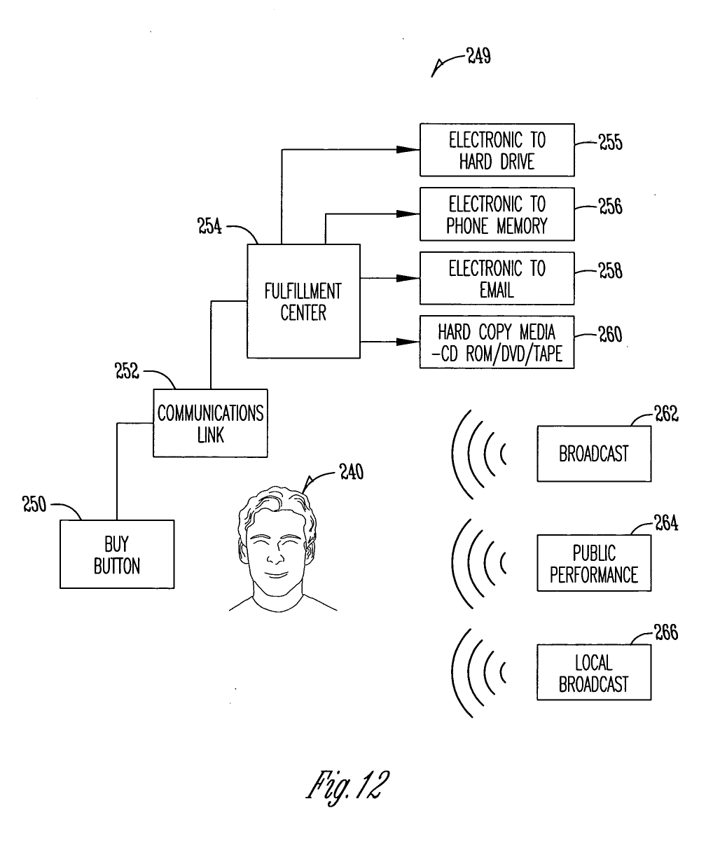

FIG. 11 illustrates one embodiment of a user interface for review of selections. The present invention contemplates that a user can review the selections they have made prior to purchase or set other purchasing options. These selection options can be accessed in any number of ways, including being reviewed online on a web page or a wireless web page. These selection options can include credit card or account information as well as information about each audio event that has been selected. Examples of the type of audio event information can include a category of music 154, a name 156 of a song, the name of an artist 158, the channel 160 on which the song was played, and a time 162 that the song was played or the time the song was selected. In addition, a price 164 for a recording of the music event can also be displayed.

The user can also make selections regarding how the recordings of the music events should be delivered. For example, the present invention contemplates that the user can have each song delivered on a separate piece of digital media. Alternatively, the user can group one or more selections on a piece of digital media such as a CD by selection option 166. Alternatively, the user can have one or more selections delivered via email by selecting option 168. The present invention also contemplates that the selections can be automatically download to a memory, such as a hard drive associated with a computer or a phone, or a satellite receiver by selecting a send as download to hard drive option 169. Then the user can finalize the order by selecting the order button 170.

The present invention contemplates that the user can preset these selections so that the user need not review this information. The user can, for example, set preferences such that every time a buy button is pressed the audio event is delivered as a CD or delivered as an MP3 to email. The present invention is flexible in this regard and contemplates numerous variations that would accommodate the preferences of a particular user.

It is preferred, that when the purchasing device is phone, that there be simple presets within the phone so that one need not even review any information after initiating a purchase. Instead, the purchase automatically occurs, and delivery is made, according to the user's presets.

FIG. 12 illustrates another embodiment of a system 249 of the present invention. In FIG. 12, a user 240 is shown. The user 240 is in proximity to one or more audio sources. The audio sources produce audio of interest to the user 240. The user indicates their desire to purchase a recording of an audio event. The identifying information for the audio event and delivery information is then transmitted trough a communications link 252 to a fulfillment center 254. The fulfillment center then provides for delivery according to the user's preferences. The present invention contemplates that delivery can be performed in any number of ways. For example, the delivery can be electronic delivery to phone memory 256, electronic delivery to an email account associated with the user, or physical delivery of a hard copy media, such as, but not limited to a CD-ROM, DVD, or tape. The electronic delivery can also be electronic delivery to a storage device 255, such as a hard drive, associated with a vehicle.

As indicated in FIG. 12, the present invention is not limited to any particular type of audio source. For example, the audio source can be a broadcast 262, such as associated with a radio or video broadcast. Alternatively, the audio source can be a public performance 264. For example, a user can request an audio recording of an audio track for a song at a movie or concert. Alternatively, the audio source can be a local broadcast 266 such as may be confined to a local vicinity, such as music playing at an amusement park, or in a historical district that a user finds of interest.

One skilled in the art will appreciate that the present invention provides benefits and advantages beyond those that most directly affect a user of the system. For example, each purchase (or selection for potential purchase) of a music event is directly tied to a channel and a time. Therefore, recording each request and each purchase provides valuable data for the purchasing agent. This data can be used to determine relationships between time of day and purchasing, particular channels and purchasing, and particular music events, and purchasing. This data can then be used to determine which music (or other audio event) to play at what time in order to increase purchases of that music. Also, this data can provide some insight into which music is not of particular interest and which music is. Thus, each purchase request can be recorded for later data analysis. Therefore, the user or purchases of a recording of an audio event will not be the only one who can benefit from the present invention.

Therefore, a system and method for purchasing of audio events has been disclosed. The present invention contemplates variations in the type of audio source, the type of communications channel, the type of purchasing device, whether it be a phone, a radio, or some other the device, the manner in which verification and purchase options are provided if they are present, the types of delivery options, and other variations within the spirit and scope of the invention now claimed.

1. A method of purchasing an audio recording, comprising:
listening to an audio event transmitted to a radio;
pressing a button to initiate purchase of a recording of the audio event.

2. The method of claim 1 wherein the audio recording is a music selection.

3. The method of claim 1 wherein the audio recording is associated with a video selection.

4. The method of claim 1 wherein the radio is a satellite radio.

5. The method of claim 1 wherein the radio is installed in a motor vehicle.

6. The method of claim 1 further comprising transmitting a request for the audio recording to a purchasing agent.

7. The method of claim 6 wherein the step of transmitting is transmitting over a cellular telephone network.

8. The method of claim 6 wherein the step of transmitting is transmitting over a satellite network.

9. The method of claim 1 further comprising verifying purchase of the audio recording.

10. The method of claim 9 wherein the step of verifying is entering a code.

11. The method of claim 1 further comprising setting up buying preferences.

12. The method of claim 11 wherein the step of setting up buying preferences is performed on a web site.

13. The method of claim 11 wherein the step of setting up buying preferences is performed on a voice automated system.

14. The method of claim 11 wherein the step of setting up buying preferences is performed on a user interface if a device comprising the button used to initiate purchase.

15. The method of claim 11 wherein the step of setting up buying preferences includes selecting a delivery option.

16. The method of claim 15 wherein the delivery option is delivery is on a CD.

17. The method of claim 16 wherein the delivery option is grouping with other audio recordings and placing on a CD.

18. The method of claim 17 wherein the delivery option is an electronic audio file.

19. The method of claim 1 wherein the audio event is an audio recording.

20. The method of claim 17 wherein the delivery option is a download to a hard drive.

21. The method of claim 20 wherein the hard drive is located in a vehicle.

22. The method of claim 1 wherein the audio event is a live audio event.

23. A system for providing radio audio and for purchasing of audio recordings, comprising:
a radio receiver for playing audio;
an intelligent control electrically connected to the radio receiver;
a transceiver operatively connected to the intelligent control for transmitting and receiving purchase information;
a user interface operatively connected to the intelligent control adapted for receiving a buy command from a user.

24. The system of claim 23 wherein the transceiver is a voice transceiver associated with a phone.

25. The system of claim 24 wherein the transceiver is operatively connected through a short range transceiver that is electrically connected to the transceiver.

26. The system of claim 25 wherein the user interface includes a buy button dedicated to receiving the buy command from the user.

27. A method of purchasing an audio recording, comprising:
playing an audio event transmitted to a radio;
receiving a purchase request from a user listening to the radio;
transmitting the purchase request over a network with audio event identifying information;
receiving verification of the purchase over the network.

28. The method of claim 27 further comprising alerting the user that the purchase has been made.

29. The method of claim 27 wherein the audio event identifying information comprises a radio channel.

30. The method of claim 27 wherein the radio is a satellite radio and wherein the radio channel is a satellite radio channel.

31. The method of claim 27 further comprising delivering an audio recording of the audio event to the user.

32. The method of claim 31 further comprising delivering video to the user that accompanies the audio event.

33. The method of claim 31 wherein the step of delivering includes delivering a digital media containing the audio recording.

34. The method of claim 31 wherein the step of delivering includes delivering a digital media containing a video recording associated with the audio recording.

35. The method of claim 31 wherein the digital media is a CD.

36. The method of claim 34 wherein the digital media is a DVD.

37. The method of claim 29 wherein the step of delivering includes delivering an electronic file containing the audio recording.

38. The method of claim 37 wherein the electronic file is an MP3 file.

39. The method of claim 27 further comprising recording information about each purchase request for later data analysis.

40. A method of selling audio recordings, comprising:
receiving a purchase request from a radio that a user is listening to;
identifying an audio recording to sell based on the purchase request;
completing a financial transaction with the user for the audio recording.

41. The method of claim 40 wherein the step of identifying includes querying a database of audio events based on a time of an audio event and a channel associated with the audio event.

42. The method of claim 40 further comprising delivering the audio recording to the user.

43. The method of claim 42 wherein the step of delivery includes delivering a digital media containing the audio recording.

44. The method of claim 42 wherein the step of delivery includes delivering a digital media containing a video recording associated with the audio recording.

45. The method of claim 43 wherein the digital media is a CD.

46. The method of claim 44 wherein the digital media is a DVD.

47. The method of claim 42 wherein the step of delivery includes delivering an electronic file containing the audio recording.

48. The method of claim 40 wherein the radio is a satellite radio.

49. The method of claim 48 wherein the satellite radio is installed in a motor vehicle.

50. A phone adapted for purchasing access to an audio recording of audio associated with a source of audio, comprising:
a phone housing;
a user interface for selecting the source of audio and initiating a purchase of the audio recording of audio associated with the source of audio;
a communications link to an ordering system for ordering access to the audio recording.

51. The phone of claim 50 wherein the access is provided by media comprising the audio recording.

52. The phone of claim 50 wherein the access is provided by media comprising a video recording associated with the audio recording.

53. The phone of claim 50 wherein the user interface comprises a buy button.

54. The phone of claim 52 wherein the buy button is joystick button.

55. The phone of claim 50 wherein the source of audio is a radio housed within the phone housing.

56. The phone of claim 50 wherein the source of audio is a sound producing device in close range wireless communication with the phone.

57. The phone of claim 50 wherein the phone further comprises a short range transceiver and is adapted to receive information about audio associated with the source of audio.

58. The phone of claim 57 wherein the source of audio is a radio with a second short range transceiver adapted to send information about audio associated with the radio.

59. The phone of claim 58 wherein the radio is a satellite radio.

60. The phone of claim 57 wherein the source of audio is a broadcast and wherein the short range transceiver receives information associated with the broadcast.

61. The phone of claim 60 wherein the broadcast is a local broadcast.

62. The phone of claim 57 wherein the source of audio is a public performance and wherein the short range transceiver receives information associated with the public performance.

63. The phone of claim 60 wherein the source of audio is selected from a plurality of sources.

64. A system for providing convenient purchase of access to a recording of audio, comprising:
a short range transceiver associated with a device for producing audio;
the short range transceiver adapted to transmit information describing the audio for use in purchasing access to the audio without transmitting the audio itself.

65. The system of claim 64 further comprising a phone comprising:
a second short range transceiver in operative communication with the short range transceiver for receiving information describing the audio; and
a voice transceiver.

66. The system of claim 65 wherein the phone further comprises a user interface for selecting the audio and initiating a purchase of the recording of audio associated with the device.

67. A method for providing convenient purchase of a recording of audio, comprising:
determining at least one source of audio proximate a user;
automatically receiving identifying information for the at least one source of audio;
receiving a request from the user for purchase of a recording of the audio.

68. The method of claim 67 wherein the steps of determining and receiving are performed by a phone.

69. The method of claim 67 wherein the step of determining at least one source of audio proximate a user is performed by a short range transceiver that receives identifying information for the at least one source of audio.

70. The method of claim 67 wherein the at least one source of audio includes a radio.

71. The method of claim 67 wherein the at least one source of audio includes a digital radio.

72. The method of claim 67 wherein the at least one source of audio includes a satellite radio receiver.

73. The method of claim 67 wherein the at least one source of audio includes an audio message broadcast via speaker proximate the user.

74. The method of claim 67 wherein the audio message is associated with a location proximate the user.

75. The method of claim 67 wherein the step of automatically receiving identifying information for the at least one source of audio is performed over a short range wireless link.

76. The method of claim 67 wherein the step of receiving the request from the user for purchase of the recording of the audio includes receiving a buy button press from the user.

77. The method of claim 67 further comprising delivering the recording of the audio.

78. The method of claim 77 wherein the step of delivering is delivering the recording of the audio to a storage device.

79. The method of claim 78 wherein the storage device is associated with a motor vehicle.

80. The method of claim 79 wherein the motor vehicle is a car.

81. The method of claim 67 wherein the audio is associated with video.

82. An entertainment device for use in a motor vehicle, comprising:
a housing;
an intelligent control disposed within the housing;
a radio receiver disposed within the housing and operatively connected to the intelligent control;
a transceiver operatively connected to the intelligent control;
a buy button for ordering audio operatively connected to the intelligent control.

83. A portable entertainment device with buy buttons, comprising:
a housing;
an intelligent control disposed within the housing;
a radio receiver disposed within the housing and operatively connected to the intelligent control;
a transceiver operatively connected to the intelligent control;
a buy button for ordering audio operatively connected to the intelligent control.

84. The entertainment device of claim 82 further comprising a storage device operatively connected to the intelligent control for storing ordered audio, and wherein the intelligent control is adapted to receive the ordered audio over the transceiver.
